(19) United States
(12) Patent Application Publication
(10) Pub. No.: US 2024/0217308 A1
(43) Pub. Date: Jul. 4, 2024

(54) THERMAL MANAGEMENT SYSTEM AND VEHICLE HAVING SAME

(71) Applicant: BYD COMPANY LIMITED, SHENZHEN (CN)

(72) Inventors: Shangzhong ZHAO, Shenzhen (CN); Junyan ZHANG, Shenzhen (CN); Yicheng PENG, Shenzhen (CN); Landong QIN, Shenzhen (CN)

(21) Appl. No.: 18/610,670

(22) Filed: Mar. 20, 2024

Related U.S. Application Data
(63) Continuation of application No. PCT/CN2022/127255, filed on Oct. 25, 2022.

(30) Foreign Application Priority Data
Oct. 29, 2021 (CN) 202111271041.0

(51) Int. Cl. B60H 1/00

(52) U.S. Cl. CPC B60H 1/00899; B60H 1/00278

(57) ABSTRACT

A thermal management system includes: a heat pump; an electric-powertrain water passage; an engine water passage; a first heat exchanger having a first heat exchange channel and a second heat exchange channel, and the first heat exchange channel being in communication with the heat pump; a battery cooling plate being in communication with the heat pump; and a control valve group being in communication with the electric-powertrain water passage, the engine water passage, and the second heat exchange channel. The control valve group is switchable between a first state and a second state. When the control valve group is in the first state, the engine water passage and the second heat exchange channel are in communication. When the control valve group is in the second state, the electric-powertrain water passage and the second heat exchange channel are in communication.

### CROSS-REFERENCE TO RELATED APPLICATIONS

The application is a continuation application of International Patent Application No. PCT/CN2022/127255 filed on Oct. 25, 2022, which is based on and claims priority to and benefits of Chinese Patent Application No. 202111271041.0, filed on Oct. 29, 2021. The entire content of all of the above-referenced applications is incorporated herein by reference.

### FIELD

The present disclosure relates to the field of vehicle technologies, and in particular, to a thermal management system and a vehicle having the same.

### BACKGROUND

In related technologies, an electric-powertrain water passage, a battery module, a heat pump module, and an engine water passage are integrated for control, so that systems can coordinate with each other, to reduce energy consumption of a vehicle, or implement heat management and proper heat distribution and utilization of the vehicle in a hybrid electric mode.

However, there is a large amount of heat redundancy between the foregoing modules during the operation or at the end of the operation. This increases energy consumption of the vehicle and reduce a driving range of the vehicle.

### SUMMARY

The present disclosure resolves at least one of the technical problems in the related art.

The present disclosure provides a thermal management system that can properly utilize heat in a vehicle and improve a driving range of the vehicle.

The thermal management system according to embodiments of the present disclosure includes: a heat pump; an electric-powertrain water passage; an engine water passage; a first heat exchanger having a first heat exchange channel and a second heat exchange channel, and the first heat exchange channel being in communication with the heat pump; a battery cooling plate being in communication with the heat pump; and a control valve group being in communication with the electric-powertrain water passage, the engine water passage, and the second heat exchange channel, and the control valve group being switchable between a first state and a second state. When the control valve group is in the first state, the engine water passage and the second heat exchange channel are in communication. When the control valve group is in the second state, the electric-powertrain water passage and the second heat exchange channel are in communication.

According to the thermal management system of embodiments of the present disclosure, the control valve group is used to control the electric-powertrain water passage and the engine water passage to exchange heat with the heat pump through the first heat exchanger. In addition, the battery cooling plate (e.g., the battery direct cooling plate) is integrated on the heat pump. The thermal management system has a high degree of integration and can properly utilize the heat generated by the various components in the vehicle during the operation. This can not only improve comfort for a user driving the vehicle, but also improve a driving range of the vehicle.

In some embodiments, the thermal management system further includes a warm-air water passage, a warm-air core being disposed on the warm-air water passage, and the warm-air water passage being in communication with the engine water passage and the second heat exchange channel through the control valve group. When the control valve group is in the first state, the engine water passage, the warm-air water passage, and the second heat exchange channel being in communication in series.

In some embodiments, the control valve group further has a third state, and when the control valve group is in the third state, the engine water passage and the warm-air water passage are in communication.

In some embodiments, the control valve group further has a fourth state, and when the control valve group is in the fourth state, the warm-air water passage is in a self circulating mode.

In some embodiments, the control valve group further has a fifth state, and when the control valve group is in the fifth state, the electric-powertrain water passage, the warm-air water passage, and the second heat exchange channel are in communication in series.

In some embodiments, the control valve group further has a sixth state, and when the control valve group is in the sixth state, the engine water passage, the electric-powertrain water passage, and the second heat exchange channel are in communication in series.

In some embodiments, the control valve group includes a first four-way valve and a first three-way valve. The first four-way valve has a first valve port, a second valve port, a third valve port, and a fourth valve port. The first valve port is in communication with a first end of the electric-powertrain water passage, the second valve port is in communication with a second end of the electric-powertrain water passage, and the third valve port is in communication with a first end of the second heat exchange channel. The first three-way valve has a fifth valve port, a sixth valve port, and a seventh valve port. The fifth valve port is in communication with a first end of the engine water passage, the sixth valve port and a second end of the engine water passage are in communication with a second end of the second heat exchange channel. The seventh valve port is in communication with the fourth valve port. When the control valve group is in the first state, the third valve port is in communication with the fourth valve port, and the fifth valve port is in communication with the seventh valve port. When the control valve group is in the second state, the first valve port is in communication with the fourth valve port, the second valve port is in communication with the third valve port, and the sixth valve port is in communication with the seventh valve port.

In some embodiments, the thermal management system further includes a warm-air water passage, a warm-air core is disposed on the warm-air water passage, and the control valve group further includes a second four-way valve. The second four-way valve has an eighth valve port, a ninth valve port, a tenth valve port, and an eleventh valve port. The eighth valve port is in communication with the first end of the engine water passage, the ninth valve port is in communication with the second end of the engine water passage, the tenth valve port is in communication with a first end of the warm-air water passage, a second end of the warm-air water passage is in communication with the second end of the second heat exchange channel, and the eleventh valve port is in communication with the fifth valve port. When the control valve group is in the first state, the eighth valve port is in communication with the eleventh valve port, the ninth valve port is in communication with the tenth valve port, and the engine water passage, the warm-air water passage, and the second heat exchange channel are in communication.

In some embodiments, the control valve group further has the third state. When the control valve group is in the third state, the fifth valve port is in communication with the sixth valve port, the eighth valve port is in communication with the eleventh valve port, the ninth valve port is in communication with the tenth valve port, and the engine water passage and the warm-air water passage are in communication.

In some embodiments, the control valve group further has the fourth state. When the control valve group is in the fourth state, the fifth valve port is in communication with the sixth valve port, the tenth valve port is in communication with the eleventh valve port, and the warm-air water passage is in a self circulating mode.

In some embodiments, the control valve group further has the fifth state. When the control valve group is in the fifth state, the first valve port is in communication with the fourth valve port, the second valve port is in communication with the third valve port, the sixth valve port is in communication with the seventh valve port, and the electric-powertrain water passage, the warm-air water passage, and the second heat exchange channel are in communication in series.

In some embodiments, the thermal management system further includes a heater. The heater is disposed between the fifth valve port and the eleventh valve port, or the heater is disposed on the warm-air water passage.

In some embodiments, the control valve group further has the sixth state. When the control valve group is in the sixth state, the first valve port is in communication with the fourth valve port, the second valve port is in communication with the third valve port, and the fifth valve port is in communication with the seventh valve port.

In some embodiments, the thermal management system further includes a first radiator water passage. A first radiator is connected to the first radiator water passage. A first end of the engine water passage is in communication with a first end of the first radiator water passage, a second end of the engine water passage is in communication with a second end of the first radiator water passage, and the engine water passage and the first radiator water passage is in communication or out of communication.

In some embodiments, the electric-powertrain water passage includes an electric-powertrain and a second radiator. The electric-powertrain and the second radiator are connected.

In some embodiments, the electric-powertrain water passage further includes: a connection branch, where the second radiator and the connection branch are in communication, and each of the second radiator and the connection branch switches between a state of being in communication with the electric-powertrain and a state of being out of communication with the electric-powertrain.

In some embodiments, the heat pump includes a compressor, an in-cabin condenser, a second heat exchanger, an in-cabin evaporator, and a gas-liquid separator. A first end of the in-cabin condenser is in communication with a first end of the compressor. A first end of the second heat exchanger is in communication with a second end of the in-cabin condenser through a pre-refrigeration branch, and a second end of the second heat exchanger is in communication with the second end of the in-cabin condenser through a pre-heating branch. A first end of the in-cabin evaporator is in communication with the second end of the second heat exchanger through a post-refrigeration branch. A first end of the gas-liquid separator is in communication with the first end of the second heat exchanger through a post-heating branch, the first end of the gas-liquid separator is in communication with a second end of the in-cabin evaporator, and a second end of the gas-liquid separator is in communication with a second end of the compressor.

In some embodiments, the battery cooling plate, the first heat exchange channel, and the in-cabin evaporator are in communication.

In some embodiments, a first two-way valve is disposed on the pre-refrigeration branch. A first one-way valve is disposed on the post-refrigeration branch, and the first one-way valve is configured to direct refrigerant of the second heat exchanger to flow to the in-cabin evaporator. A second two-way valve, a first expansion valve, and a second one-way valve are disposed on the pre-heating branch, and the second one-way valve is configured to direct refrigerant of the in-cabin condenser to flow to the second heat exchanger. A third two-way valve is disposed on the post-heating branch.

In some embodiments, the pre-heating branch includes a first section and a second section. A first end of the first section is in communication with the second end of the in-cabin condenser, and a second end of the first section is in communication with the first one-way valve and the first end of the in-cabin evaporator. A first end of the second section is in communication with the second end of the first section, and a second end of the second section is in communication with the second end of the second heat exchanger. The second two-way valve is disposed on the first section, and the first expansion valve and the second one-way valve are disposed on the second section.

In some embodiments, the gas-liquid separator includes a first flow path and a second flow path. A first end of the first flow path is in communication with the first one-way valve and the second end of the first section, and a second end of the first flow path is in communication with the first end of the in-cabin evaporator and the first end of the second section. A first end of the second flow path is in communication with the second end of the in-cabin evaporator, the post-heating branch, and the first end of the second heat exchanger, and a second end of the second flow path is in communication with the second end of the compressor.

A vehicle according to embodiments of the present disclosure includes a thermal management system according to any of the foregoing.

According to the vehicle in embodiments of the present disclosure, the heat pump module or the heat pump, the electric-powertrain water passage, the engine water passage, and the battery direct cooling plate arranged/disposed on the vehicle are controlled and adjusted by using the thermal management system, to properly utilize heat generated during operation of the vehicle and improve a driving range of the vehicle.

The additional aspects and advantages of the present disclosure will be provided in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible from the following descriptions of the embodiments with reference to the accompanying drawings, where:

FIG. 1 is a schematic structural diagram of a thermal management system according to an embodiment of the present disclosure;

FIG. 2 is a schematic structural diagram of a thermal management system according to an embodiment of the present disclosure;

FIG. 3 is a schematic structural diagram of a thermal management system according to an embodiment of the present disclosure;

FIG. 4 is a schematic structural diagram of a thermal management system according to an embodiment of the present disclosure;

FIG. 5 is a schematic structural diagram of a thermal management system according to an embodiment of the present disclosure;

FIG. 6 is a schematic structural diagram of a thermal management system according to an embodiment of the present disclosure;

FIG. 7 is a schematic structural diagram of a thermal management system according to an embodiment of the present disclosure;

FIG. 8 is a schematic structural diagram of a thermal management system according to an embodiment of the present disclosure;

FIG. 9 is a schematic structural diagram of a thermal management system according to an embodiment of the present disclosure;

FIG. 10 is a schematic structural diagram of a thermal management system according to an embodiment of the present disclosure;

FIG. 11 is a schematic structural diagram of a thermal management system according to an embodiment of the present disclosure; and

FIG. 12 is a schematic block diagram of a vehicle according to an embodiment of the present disclosure.

### REFERENCE NUMERALS

thermal management system 1;
heat pump module 100, compressor 110, in-cabin condenser 120, second heat exchanger 140, in-cabin evaporator 150, gas-liquid separator 160, first flow path 161, second flow path 162, reservoir 163, pre-refrigeration branch 170, first two-way valve 171, post-refrigeration branch 190, first one-way valve 191, pre-heating branch 1100, second one-way valve 1101, second two-way valve 1102, first expansion valve 1103, first section 1104, second section 1105, post-heating branch 1110, third two-way valve 1111;
electric-powertrain water passage 200, electric-powertrain 201, motor 210, motor controller 220, motor water pump 230, second radiator 240, direct connection branch 250;
engine water passage 310, engine 311, first radiator 312, first radiator water passage 313, warm-air water passage 320, warm-air core 321, warm-air water pump 322, heater 323, second four-way valve 331, eighth valve port 332, ninth valve port 333, tenth valve port 334, and eleventh valve port 335;
battery direct cooling plate 400, second expansion valve 410;
first heat exchanger 500, first heat exchange channel 510, second heat exchange channel 520;
control valve group 600, first four-way valve 610, first valve port 611, second valve port 612, third valve port 613, fourth valve port 614, first three-way valve 620, fifth valve port 621, sixth valve port 622, seventh valve port 623; and
exhaust heat exchanger 700, vehicle 1000.

### DETAILED DESCRIPTION

The embodiments of the present disclosure are described below in detail. Examples of the embodiments are shown in the accompanying drawings, and same or similar reference signs in all the accompanying drawings indicate same or similar components or components having same or similar functions. The embodiments described below with reference to the accompanying drawings are examples, and are merely to explain the present disclosure and cannot be construed as a limitation to the present disclosure.

In the description of the present disclosure, it should be understood that orientation or position relationships indicated by the terms such as “center”, “longitudinal”, “transverse”, “length”, “width”, “thickness”, “on”, “below”, “front”, “back”, “left”, “right”, “vertical”, “horizontal”, “top”, “bottom”, “inside”, “outside”, “clockwise”, “anticlockwise”, “axial”, “radial”, and “circumferential” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as limiting of the present disclosure. In addition, a feature defined to be “first” or “second” may explicitly or implicitly include one or more features. In the description of the present disclosure, unless stated otherwise, the meaning of “a plurality of” is two or more than two.

In addition, terms “first”, “second”, and “third” are used merely for the purpose of description, and shall not be construed as indicating or implying relative importance or implying a quantity of indicated technical features. Therefore, a feature restricted by “first”, “second”, or “third” may explicitly indicate or implicitly include at least one of such features. In the descriptions of the present disclosure, unless explicitly specified, “multiple” means at least two, for example, two or three. All directional indications (such as up, down, left, right, front, back . . . ) in the embodiments of the present disclosure are only used to explain the relative positional relationship between components in a posture (as shown in the accompanying drawings, movement conditions, and the like. If the posture changes, the directional indications also change accordingly. In addition, the terms “include”, “have”, and any variant thereof are to cover a non-exclusive inclusion. For example, a process, method, system, product, or device that includes a series of steps or units is not limited to the listed steps or units; and instead, further includes a step or unit that is not listed, or further includes another step or unit that is intrinsic to the process, method, product, or device.

“Embodiment” mentioned in the present disclosure means that particular features, structures, or characteristics described with reference to the embodiment may be included in at least one embodiment of the present disclosure. The term appearing at different positions of the specification may not necessarily refer to the same embodiment, nor separate or alternative embodiments mutually exclusive of other embodiments. A person skilled in the art explicitly or implicitly understands that the embodiments described in the specification may be combined with other embodiments.

The embodiments of the present disclosure are described in detail below, and the embodiments described with reference to accompanying drawings are examples.

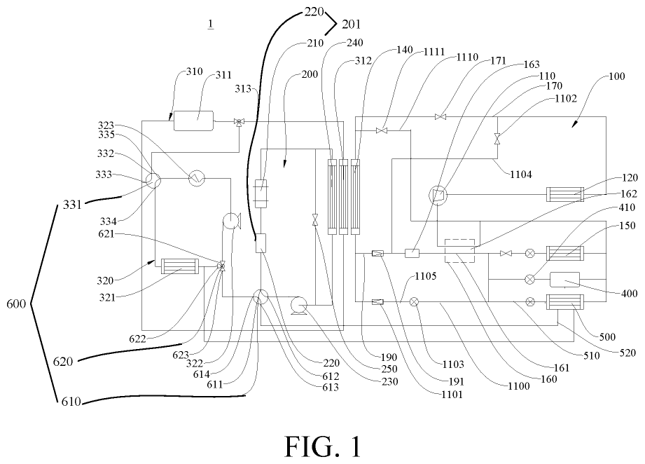

A thermal management system 1 according to the embodiments of the present disclosure is described below with reference to FIG. 1 to FIG. 11. As shown in FIG. 1, the thermal management system 1 includes a heat pump module 100 (e.g., a heat pump), an electric-powertrain water passage 200, an engine water passage 310, a first heat exchanger 500, a battery direct cooling plate 400, and a control valve group 600. The electric-powertrain water passage 200 is connected to an electric-powertrain 201 (including a motor 210 and a motor controller 220), and the electric-powertrain 201 exchanges heat with coolant in the electric-powertrain water passage 200. The engine water passage 310 is connected to an engine 311, and the engine 311 exchanges heat with coolant in the engine water passage 310. The battery direct cooling plate 400 is arranged on a battery of a vehicle, and the battery exchanges heat with refrigerant flowing through the battery direct cooling plate 400.

In an embodiment, the first heat exchanger 500 has a first heat exchange channel 510 and a second heat exchange channel 520. The battery direct cooling plate 400 is in communication with the heat pump module 100. The control valve group 600 is in communication with all the electric-powertrain water passage 200, the engine water passage 310, and the second heat exchange channel 520, and the control valve group 600 is switchable between a first state and a second state. When the control valve group 600 is in the first state, the engine water passage 310 and the second heat exchange channel 520 are in communication in series. When the control valve group 600 is in the second state, the engine water passage 310, the electric-powertrain water passage 200, and the second heat exchange channel 520 are in communication in series.

It should be noted that the first heat exchanger 500 may be a plate heat exchanger. The plate heat exchanger enables coolant or refrigerant to exchange heat. When the control valve group 600 is in the first state, the engine water passage 310 is in communication with the second heat exchange channel 520 on the first heat exchanger 500, so that the heat pump module 100 can absorb excess heat of the engine 311. In addition, when the control valve group 600 is in the second state, the electric-powertrain water passage 200 is in communication with the second heat exchange channel 520 on the first heat exchanger 500, so that the heat pump module 100 can absorb excess heat of the electric-powertrain 201. Therefore, energy utilization efficiency of the thermal management system 1 is improved. In addition, the engine water passage 310, the electric-powertrain water passage 200, and the heat pump module 100 are integrated through the first heat exchanger 500, so that the thermal management system 1 has a higher degree of integration.

In addition, each component in the thermal management system 1 has an independent operation function. In other words, the heat pump module 100, the battery direct cooling plate 400, the engine water passage 310, and the electric-powertrain water passage 200 each can perform an independent circulation cooling mode or heating mode for operation and use.

According to the thermal management system 1 of this embodiment of the present disclosure, the control valve group 600 is used to control the electric-powertrain water passage 200 and the engine water passage 310 to exchange heat with the heat pump module 100 through the first heat exchanger 500. In addition, the battery direct cooling plate 400 is integrated on the heat pump module 100, so that a flow path of energy circulated in the thermal management system 1 can be adjusted according to usage requirements. Therefore, the thermal management system 1 has higher energy utilization efficiency, and the thermal management system 1 further has a high degree of integration and can properly utilize heat generated by the various components in the vehicle during operation. This can improve comfort for a user driving the vehicle, and can improve a driving range of the vehicle.

In some embodiments, as shown in FIG. 1 to FIG. 11, the control valve group 600 includes a first four-way valve 610 and a first three-way valve 620. The first four-way valve 610 has a first valve port 611, a second valve port 612, a third valve port 613, and a fourth valve port 614. The first valve port 611 is in communication with one end (e.g., a first end) of the electric-powertrain water passage 200. The second valve port 612 is in communication with the other end (e.g., a second end) of the electric-powertrain water passage 200. The third valve port 613 is in communication with one end (e.g., a first end) of the second heat exchange channel 520. The first three-way valve 620 has a fifth valve port 621, a sixth valve port 622, and a seventh valve port 623. The fifth valve port 621 is in communication with one end (e.g., a first end) of the engine water passage 310. The sixth valve port 622, the other end (e.g., a second end) of the engine water passage 310, and the other end (e.g., a second end) of the second heat exchange channel 520 are in communication with each other. The seventh valve port 623 is in communication with the fourth valve port 614.

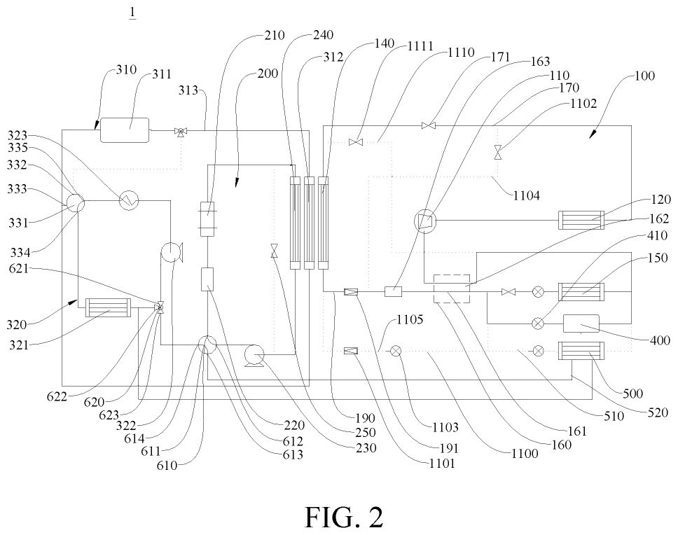

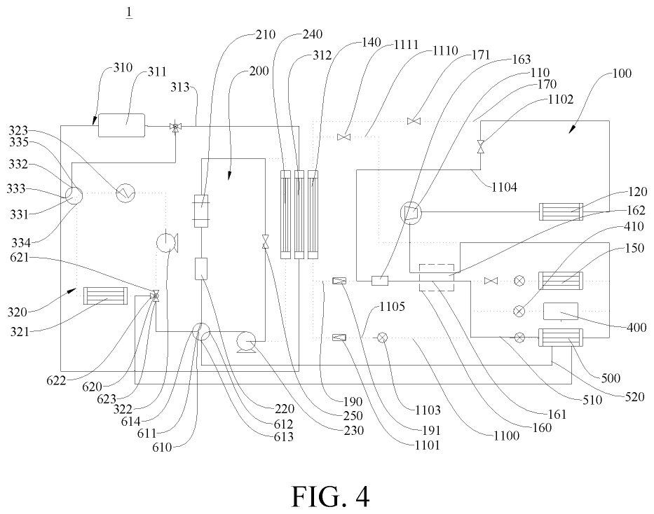

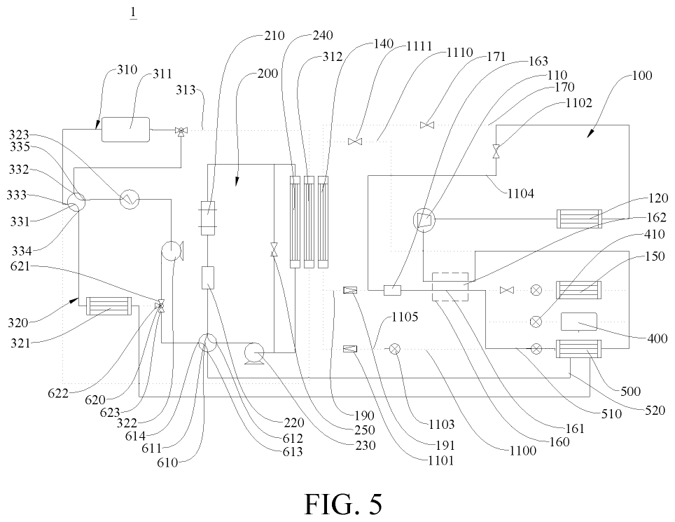

It can be understood that during use, the control valve group 600 may select communication statuses of the first four-way valve 610 and the first three-way valve 620, to control a use mode of the electric-powertrain water passage 200 and the engine water passage 310. The electric-powertrain water passage 200 can circulate independently for heating or cooling (as shown in FIG. 2), or the electric-powertrain water passage 200 can be in communication with the second heat exchange channel 520 for heating or cooling (as shown in FIG. 4), or the engine water passage 310 can circulate independently for heating or cooling (as shown in FIG. 2), or the engine water passage 310 can be in communication with the second heat exchange channel 520 for heating or cooling (as shown in FIG. 5). With this configuration, the first heat exchanger 500 can participate in a circulation process of the electric-powertrain water passage 200 or the engine water passage 310, so that the heat pump module 100 absorbs and utilizes excess heat of the engine 311 or the electric-powertrain 201, to improve energy utilization efficiency of the thermal management system 1.

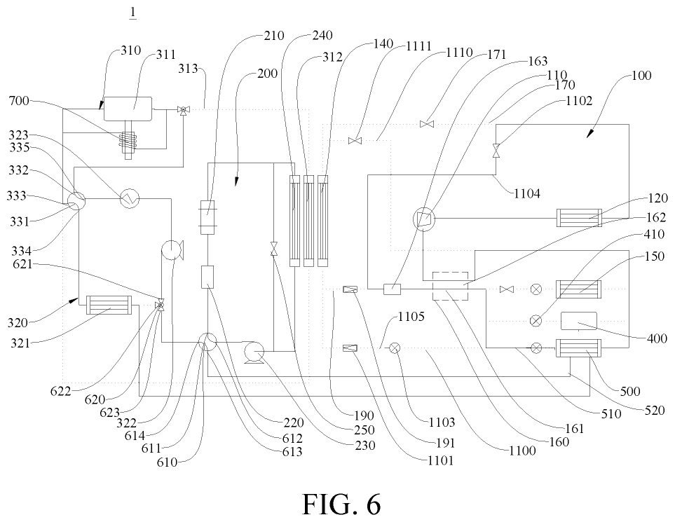

When the control valve group 600 is in the first state, as shown in FIG. 5 and FIG. 6, the third valve port 613 is in communication with the fourth valve port 614, and the fifth valve port 621 is in communication with the seventh valve port 623. When the control valve group 600 is in the second state, the first valve port 611 is in communication with the fourth valve port 614, the second valve port 612 is in communication with the third valve port 613, and the sixth valve port 622 is in communication with the seventh valve port 623.

In an embodiment, when the control valve group 600 is in the first state, one end (e.g., a first end) of the engine water passage 310 is in communication with one end (e.g., a first end) of the second heat exchange channel 520, the other end (e.g., a second end) of the second heat exchange channel 520 is in communication with the third valve port 613, the third valve port 613 is in communication with the fourth valve port 614, the fourth valve port 614 is in communication with the seventh valve port 623, the seventh valve port 623 is in communication with the fifth valve port 621, and the fifth valve port 621 is in communication with the other end (e.g., a second end) of the engine water passage 310, so that the engine water passage 310 and the second heat exchange channel 520 are in communication in series. In this case, the first valve port 611 and the second valve port 612 in the first four-way valve 610 can also be in communication, so that the electric-powertrain water passage 200 works in a form of independent circulation. This facilitates precise control of heat dissipation of the electric-powertrain water passage 200.

When the control valve group 600 is in the second state, as shown in FIG. 4, one end of the electric-powertrain water passage 200 is in communication with the first valve port 611, the first valve port 611 is in communication with the fourth valve port 614, the fourth valve port 614 is in communication with the seventh valve port 623, the seventh valve port 623 is in communication with the sixth valve port 622, the sixth valve port 622 is in communication with the other end of the second heat exchange channel 520, one end of the second heat exchange channel 520 is in communication with the third valve port 613, the third valve port 613 is in communication with the second valve port 612, and the second valve port 612 is in communication with the other end of the electric-powertrain water passage 200. That is, the electric-powertrain water passage 200 and the second heat exchange channel 520 are in communication in series. The first four-way valve 610 and the first three-way valve 620 of the control valve group 600 are arranged, and the first four-way valve 610 and the first three-way valve 620 are controlled to switch between multiple modes. In a simple, effective, and controllable manner, the thermal management system 1 has a high degree of integration and can properly utilize heat generated by various modules in the vehicle during operation. This can not only improve comfort for a user driving the vehicle, but also improve a driving range of the vehicle.

In some embodiments, as shown in FIG. 1 to FIG. 11, the thermal management system 1 further includes a warm-air water passage 320. A warm-air core 321 is arranged on the warm-air water passage 320, and the warm-air water passage 320 is connected to the second heat exchange channel 520 through the control valve group 600 and the engine water passage 310. As shown in FIG. 5 and FIG. 6, when the control valve group 600 is in the first state, the engine water passage 310, the warm-air water passage 320, and the second heat exchange channel 520 are in communication in series. It can be understood that a warm-air water pump 322 may further be arranged on the warm-air water passage 320. The warm-air water pump 322 is suitable for driving coolant in the warm-air water passage 320 to circulate, so that the coolant can dissipate heat on the warm-air core 321, to implement a heating function of the warm-air core 321 for a passenger compartment and improve comfort for driving the vehicle.

In an embodiment, the thermal management system 1 further includes the warm-air water passage 320, and the warm-air core 321 is arranged on the warm-air water passage 320. The control valve group 600 further includes a second four-way valve 331, the second four-way valve 331 has an eighth valve port 332, a ninth valve port 333, a tenth valve port 334, and an eleventh valve port 335. The eighth valve port 332 is in communication with one end of the engine water passage 310. The ninth valve port 333 is in communication with the other end of the engine water passage 310. The tenth valve port 334 is in communication with one end (e.g., a first end) of the warm-air water passage 320, and the other end (e.g., a second end) of the warm-air water passage 320 is in communication with the other end of the second heat exchange channel 520. The eleventh valve port 335 is in communication with the fifth valve port 621. As shown in FIG. 5 and FIG. 6, when the control valve group 600 is in the first state, the eighth valve port 332 is in communication with the eleventh valve port 335, and the ninth valve port 333 is in communication with the tenth valve port 334, so that the engine water passage 310, the warm-air water passage 320, and the second heat exchange channel 520 are in communication in series.

Certainly, the warm-air water passage 320 can circulate independently to provide heat for the passenger compartment in the vehicle, or can be in communication with the engine water passage 310 or the first heat exchanger 500 according to usage of the vehicle, to improve energy utilization efficiency of the thermal management system 1, so as to improve a driving range of the vehicle.

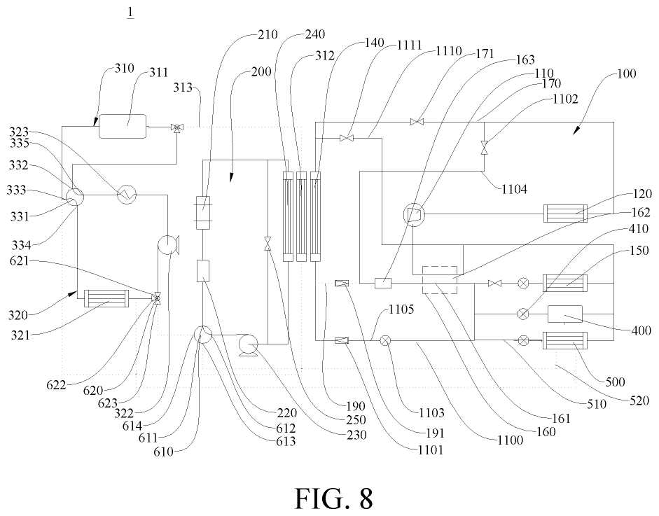

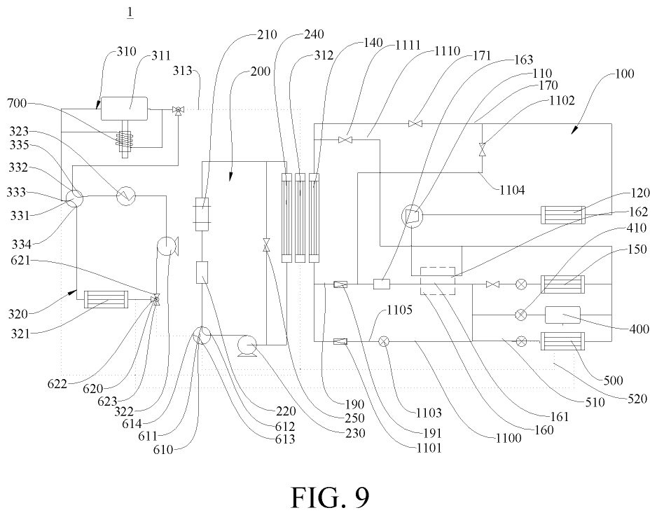

In some embodiments, the control valve group 600 further has a third state. When the control valve group 600 is in the third state, as shown in FIG. 8 and FIG. 9, the engine water passage 310 and the warm-air water passage 320 are in communication in series. Therefore, the control valve group 600 is adjusted to the third state, so that the engine water passage 310 and the warm-air water passage 320 are in communication, and excess heat on the engine 311 can be transferred to the warm-air core 321 through coolant, to implement a heating function of the warm-air core 321 for the passenger compartment.

In an embodiment, when the control valve group 600 is in the third state, as shown in FIG. 8 and FIG. 9, the fifth valve port 621 is in communication with the sixth valve port 622, the eighth valve port 332 is in communication with the eleventh valve port 335, and the ninth valve port 333 is in communication with the tenth valve port 334, so that the engine water passage 310 and the warm-air water passage 320 are in communication in series.

In this way, the engine water passage 310 and the warm-air water passage 320 are in communication under the control of the control valve group 600, and heat on the engine 311 can be supplied to the warm-air water passage 320 for use through circulation of coolant. Heating performance of the warm-air core 321 can be improved, the warm-air water passage 320 can more quickly heat the interior of the vehicle to a temperature required by the user, and working efficiency of the warm-air water passage 320 can be improved. In addition, the warm-air water passage 320 can also use excess heat of the engine 311, so that the thermal management system 1 properly utilizes heat in the vehicle, to improve a driving range of the vehicle.

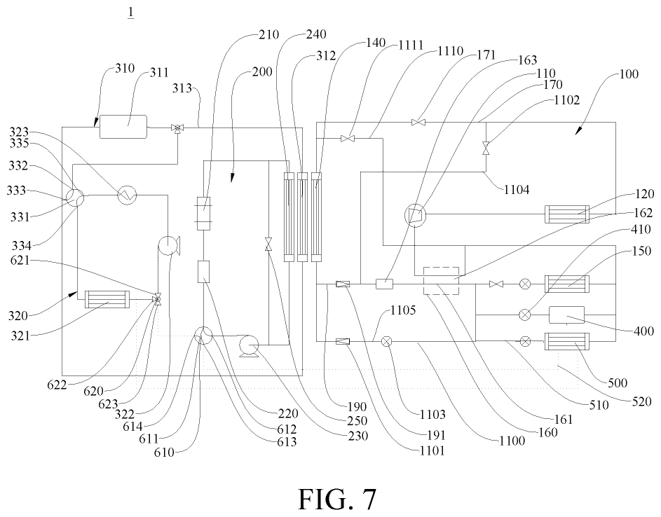

In some embodiments, the control valve group 600 further has a fourth state. When the control valve group 600 is in the fourth state, as shown in FIG. 7, the warm-air water passage 320 is in a self circulating mode, that is, the medium is circulated in the warm-air water passage 320 without communication to other components of the system. With this configuration, the control valve group 600 is in the fourth state, and the warm-air water passage 320 circulates independently to implement the heating function.

In an embodiment, the control valve group 600 further has the fourth state. When the control valve group 600 is in the fourth state, as shown in FIG. 7, the fifth valve port 621 is in communication with the sixth valve port 622, and the tenth valve port 334 is in communication with the eleventh valve port 335, so that warm-air water passage 320 is in a self circulating mode.

In this way, when the control valve group 600 is in the fourth state, the tenth valve port 334 is in communication with the eleventh valve port 335, so that the engine water passage 310 is in an independent operating state. This facilitates accurate thermal management of the engine 311, so that the engine 311 work in an efficient state. In this case, the ninth valve port 333 is in communication with the tenth valve port 334, and the warm-air water passage 320 can also operate independently, and can implement a heating function, to improve comfort of the vehicle.

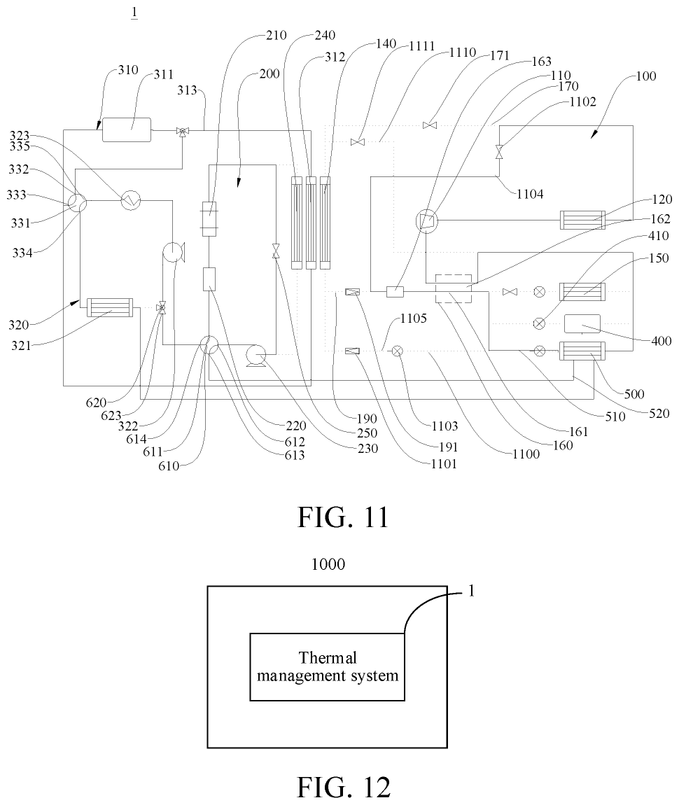

In some embodiments, the control valve group 600 further has a fifth state. When the control valve group 600 is in the fifth state, as shown in FIG. FIG. 11, the electric-powertrain water passage 200 and the warm-air water passage 320 are in communication in series. Therefore, the control valve group 600 is adjusted to the fifth state, so that the electric-powertrain water passage 200 and the warm-air water passage 320 are in communication, and excess heat on the electric-powertrain 201 can be transferred to the warm-air core 321 through coolant, to implement a heating function of the warm-air core 321 for the passenger compartment.

In an embodiment, when the control valve group 600 is in the fifth state, as shown in FIG. 11, the first valve port 611 is in communication with the fourth valve port 614, the second valve port 612 is in communication with the third valve port 613, and the sixth valve port 622 is in communication with the seventh valve port 623, so that the electric-powertrain water passage 200 and the warm-air water passage 320 are in communication in series.

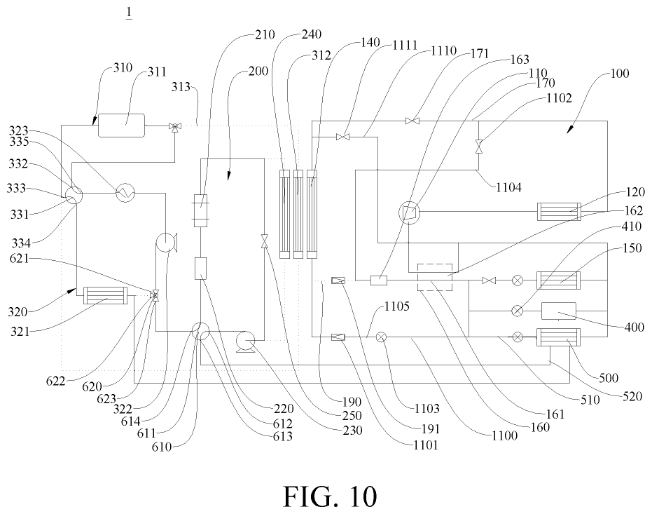

In some embodiments, the control valve group 600 further has a sixth state. When the control valve group 600 is in the sixth state, as shown in FIG. 10, the engine water passage 310, the electric-powertrain water passage 200, and the second heat exchange channel 520 are in communication in series.

In an embodiment, when the control valve group 600 is in the sixth state, as shown in FIG. 10, the first valve port 611 is in communication with the fourth valve port 614, the second valve port 612 is in communication with the third valve port 613, and the fifth valve port 621 is in communication with the seventh valve port 623. In some embodiments, when the control valve group 600 is in the sixth state, as shown in FIG. 10, the engine water passage 310, the warm-air water passage 320, the electric-powertrain water passage 200, and the second heat exchange channel 520 are in communication in series, the first valve port 611 is in communication with the fourth valve port 614, the second valve port 612 is in communication with the third valve port 613, the fifth valve port 621 is in communication with the seventh valve port 623, the eighth valve port 332 is in communication with the eleventh valve port 335, and the ninth valve port 333 is in communication with the tenth valve port 334.

It should be noted that when the engine water passage 310 and the electric-powertrain water passage 200 are in communication with the second heat exchange channel 520, excess heat of the engine 311 can be transferred to the electric-powertrain 201 to heat the electric-powertrain 201, and can also be transferred to the heat pump module 100 through the second heat exchange channel 520, so that heating performance of the heat pump module 100 is improved.

In some embodiments, as shown in FIG. 1 to FIG. 11, the thermal management system 1 further includes a heater 323. The heater 323 is arranged between the fifth valve port 621 and the eleventh valve port 335, or the heater 323 is arranged on the warm-air water passage 320.

It can be understood that the heater 323 can provide more heat after start, and the heat can flow to the warm-air core 321 through circulation of the warm-air water passage 320, so that heating performance of the warm-air core 321 is improved. In some embodiments, as shown in FIG. 1 to FIG. 11, the heater 323 may be a PTC heater, and the PTC heater 323 may be in communication with the warm-air water pump 322 in series. With this configuration, when the vehicle requires higher temperature heating, the PTC heater 323 can be turned on according to a situation, to provide more heat to participate in coolant circulation, so that performance of the warm-air core 321 can be improved, and heating efficiency in the vehicle is improved.

In addition, when the electric-powertrain 201 has a large heating demand, the control valve group 600 can be set to the fifth state. That is, the electric-powertrain water passage 200, the warm-air water passage 320, and the second heat exchange channel 520 are in communication in series, and the heater 323 is started, to heat the electric-powertrain 201. When the engine 311 needs to be warmed up, the control valve group 600 can be set to the third state. That is, the engine water passage 310 and the warm-air water passage 320 are in communication in series, and the heater 323 is started, to warm up the engine 311.

In some embodiments, as shown in FIG. 1 to FIG. 11, the thermal management system 1 further includes a first radiator water passage 313, and a first radiator 312 is connected to the first radiator water passage 313. One end of the engine water passage 310 is in communication with one end of (e.g., a first end) the first radiator water passage 313, the other end of the engine water passage 310 is in communication with the other end (e.g., a second end) of the first radiator water passage 313, and the engine water passage 310 and the first radiator water passage 313 are selectively in communication in series or out of communication.

It should be noted that the engine 311 is in communication with the first radiator water passage 313, so that coolant flowing in the engine 311 dissipates heat from the engine 311. With this configuration, the first radiator water passage 313 is in communication with the engine water passage 310, so that a heat dissipation effect of the engine water passage 310 is improved, and the engine 311 is used more stably and efficiently.

In some embodiments, as shown in FIG. 1 to FIG. 11, the electric-powertrain water passage 200 further includes a second radiator 240. The electric-powertrain 201 and the second radiator 240 are connected in series. It should be noted that as shown in FIG. 1 to FIG. 11, the electric-powertrain water passage 200 includes a motor 210, a motor controller 220, a motor water pump 230, and the second radiator 240. The motor 210, the motor controller 220, the motor water pump 230, and the second radiator 240 are connected in series. It can be understood that the motor water pump 230 can drive coolant to circulate, so that the coolant can circulate along the motor water pump 230, the motor controller 220, the motor 210, and the second radiator 240 in sequence, to dissipate heat from the motor 210 and the motor controller 220 by using the second radiator 240.

In some embodiments, as shown in FIG. 1 to FIG. 11, the electric-powertrain water passage 200 further includes a connection branch (e.g., a direct connection branch 250). The second radiator 240 and the direct connection branch 250 are in communication in parallel. The second radiator 240 and the direct connection branch 250 each switch between a state of being in communication with the electric-powertrain 201 in series and a state of being out of communication with the electric-powertrain 201.

In this way, when the direct connection branch 250 is in communication, coolant does not communicate through the second radiator 240 during circulation, to prevent heat from being dissipated by the second radiator 240 when the electric-powertrain 201 needs to be heated.

In some embodiments, as shown in FIG. 1 to FIG. 11, the heat pump module 100 includes a compressor 110, an in-cabin condenser 120, a second heat exchanger 140, an in-cabin evaporator 150, and a gas-liquid separator 160. One end (e.g., a first end) of the in-cabin condenser 120 is in communication with one end (e.g., a first end) of the compressor 110. One end (e.g., a first end) of the second heat exchanger 140 is in communication with the other end (e.g., a second end) of the in-cabin condenser 120 through a pre-refrigeration branch 170, and the other end (e.g., a second end) of the second heat exchanger 140 is in communication with the other end of the in-cabin condenser 120 through a pre-heating branch 1100. One end (e.g., a first end) of the in-cabin evaporator 150 is in communication with the other end of the second heat exchanger 140 through a post-refrigeration branch 190. One end (e.g., a first end) of the gas-liquid separator 160 is in communication with one end of the second heat exchanger 140 through a post-heating branch 1110, one end of the gas-liquid separator 160 is in communication with the other end (e.g., a second end) of the in-cabin evaporator 150, and the other end (e.g., a second end) of the gas-liquid separator 160 is in communication with the other end (e.g., a second end) of the compressor 110.

In other words, the compressor 110, the in-cabin condenser 120, the second heat exchanger 140, the in-cabin evaporator 150, and the gas-liquid separator 160 are connected in series. In addition, the battery direct cooling plate 400, the first heat exchange channel 510, and the in-cabin evaporator 150 are connected in parallel. In addition, when the heat pump module 100 is in use, the battery direct cooling plate 400, the first heat exchange channel 510 and the in-cabin evaporator 150 can be in communication in parallel, so that refrigerant entering the compressor 110 can absorb heat of components such as the battery, the engine 311, and the electric-powertrain 201. Heat generated by the vehicle during operation and use can be utilized more properly, and the vehicle has a high degree of integration, to improve a driving range of the vehicle.

In some embodiments, as shown in FIG. 1 to FIG. 11, a first two-way valve 171 is arranged on the pre-refrigeration branch 170. A first one-way valve 191 is arranged on the post-refrigeration branch 190, and the first one-way valve 191 allows or is configured to direct refrigerant of the second heat exchanger 140 to flow to the in-cabin evaporator 150. A second two-way valve 1102, a first expansion valve 1103, and a second one-way valve 1101 are arranged on the pre-heating branch 1100, and the second one-way valve 1101 allows or is configured to direct refrigerant of the in-cabin condenser 120 to flow to the second heat exchanger 140. A third two-way valve 1111 is arranged on the post-heating branch 1110.

It can be understood that the first two-way valve 171 controls whether refrigerant flows to the pre-refrigeration branch 170 for circulation, and the first one-way valve 191 controls flowing of refrigerant in the post-refrigeration branch 190, to control whether the refrigerant can flow to the in-cabin evaporator 150 through the second heat exchanger 140 without reverse flow, to implement a refrigeration function of the heat pump module 100. The second two-way valve 1102, the first expansion valve 1103, and the second one-way valve 1101 control flowing of refrigerant in the pre-heating branch 1100, to control whether the refrigerant flows through the pre-heating branch 1100. The third two-way valve 1111 controls whether the refrigerant flows through the post-heating branch 1110 without reverse flow, to implement a heating function of the heat pump module 100.

In some embodiments, the pre-heating branch 1100 includes a first section 1104 and a second section 1105. One end (e.g., a first end) of the first section 1104 is in communication with the other end of the in-cabin condenser 120, and the other end (e.g., a second end) of the first section 1104 is in communication with the first one-way valve 191 and one end of the in-cabin evaporator 150. One end (e.g., a first end) of the second section 1105 is in communication with the other end of the first section 1104, and the other end (e.g., a second end) of the second section 1105 is in communication with the other end of the second heat exchanger 140. The second two-way valve 1102 is arranged on the first section 1104, and the first expansion valve 1103 and the second one-way valve 1101 are arranged on the second section 1105. In this way, the first section 1104 and the second section 1105 form the pre-heating branch 1100, so that refrigerant flowing in the pre-heating branch 1100 can be controlled to flow to different structures for heat exchange, to implement multiple working modes of the heat pump module 100 under different working conditions.

In some embodiments, as shown in FIG. 1 to FIG. 11, the gas-liquid separator 160 includes a first flow path 161 and a second flow path 162. One end (e.g., a first end) of the first flow path 161 is in communication between the second heat exchanger 140 and the in-cabin evaporator 150. A liquid reservoir 163 is arranged on the first flow path 161. The second flow path 162 is in communication between the in-cabin evaporator 150 and the compressor 110. In this way, the first flow path 161 and the second flow path 162 provided on the gas-liquid separator 160 can separate gas and liquid of refrigerant during use, so that drier refrigerant participates in circulation, and the refrigerant does not affect normal operation of the compressor 110 when entering the compressor 110, to improve safety and reliability of the heat pump module 100.

As shown in FIG. 12, a vehicle 1000 according to an embodiment of the present disclosure includes the thermal management system 1 according to any one of the above embodiments. During use of the vehicle 1000, to improve a user's comfort during driving of the vehicle, a cooling mode or a heating mode can be turned on in the vehicle 1000 to improve comfort in a cab of the vehicle 1000.

In this way, the thermal management system 1 in this application can properly utilize heat generated by the vehicle 1000 during driving to improve a driving range of the vehicle 1000 during driving, and can improve effect of the vehicle 1000 in the cooling mode or the heating mode to reduce an energy consumption ratio of the vehicle 1000 during use, so that the vehicle 1000 has a larger range.

Various working modes of interaction between the heat pump module 100, the electric-powertrain water passage 200, the engine water passage 310, the warm-air water passage 320, and the battery direct cooling plate 400 in the thermal management system 1 are described in detail below with reference to FIG. 2 to FIG. 10.

Passenger compartment cooling mode: As shown in FIG. 2, when the passenger compartment needs to be cooled in summer, refrigerant is compressed in the compressor 110 and output from one end of the compressor 110, so that the refrigerant circulates along the in-cabin condenser 120 (which does not work, only allows the refrigerant through), the second heat exchanger 140, the in-cabin evaporator 150, and the gas-liquid separator 160 in sequence, and finally returns to the compressor 110 to complete circulation. In this process, low-temperature refrigerant evaporates and absorbs heat at the in-cabin evaporator 150, to cool the passenger compartment. High-temperature refrigerant condenses and releases heat at the second heat exchanger 140, to release heat into the air. In an embodiment, the second heat exchanger 140 is an air-cooled heat exchanger arranged in a front compartment (engine compartment) of the vehicle.

Battery cooling mode: As shown in FIG. 2, when the battery needs to be cooled, the second expansion valve 410 is opened to allow low-temperature refrigerant in the heat pump module 100 to enter the battery direct cooling plate 400, so that the refrigerant can pass through the battery direct cooling plate 400 during circulation, to absorb the heat from the battery. This not only cools the battery, but also allows excess heat of the battery to be absorbed and utilized to reduce energy consumption of the thermal management system 1.

Electric-powertrain 201 cooling mode: As shown in FIG. 2, when components of the motor 210 need to be cooled, coolant circulates independently in the electric-powertrain water passage 200. In this mode, the second radiator 240 and the electric-powertrain 201 are in communication in series, and the direct connection branch 250 and the electric-powertrain 201 are out of communication. In other words, the refrigerant can circulate along the motor controller 220, the motor 210, and the second radiator 240 in sequence, to cool the motor 210 and the motor controller 220 by using the second radiator 240. The second radiator 240 is an air-cooled radiator arranged in the front compartment (engine compartment) of the vehicle.

Engine cooling mode: As shown in FIG. 2, when the engine 311 needs to be cooled and there is a large cooling demand, coolant is in series communication between the engine water passage 310 and the first radiator water passage 313 to perform large cooling circulation. That is, the coolant is circulated between the engine 311 and the first radiator 312 to cool the engine 311 by the first radiator 312. The first radiator 312 is an air-cooled radiator arranged in the front compartment (engine compartment) of the vehicle.

In addition, when the engine 311 needs to be cooled and there is a small cooling demand, the coolant flows in the engine water passage 310 to perform small cooling circulation. In other words, communication between the first radiator water passage 313 and the engine water passage 310 is disconnected, and the coolant is used to cool the engine 311.

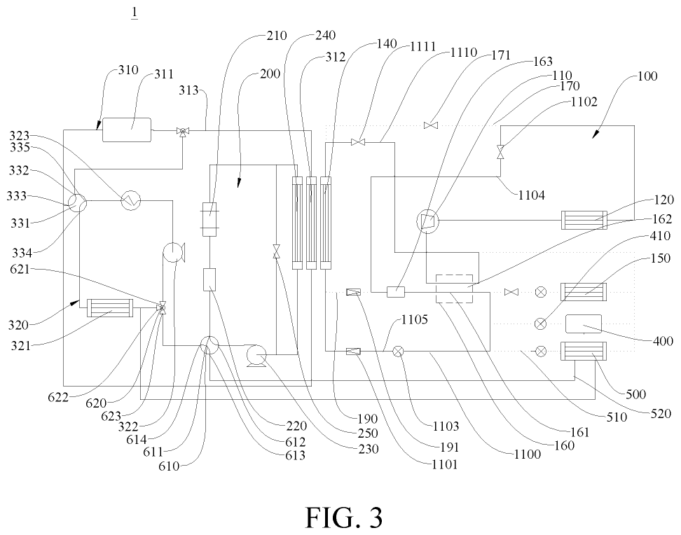

Passenger compartment heating mode 1: As shown in FIG. 3, when the passenger compartment of the vehicle needs to be heated in a cold environment, the pre-heating branch 1100 and the post-heating branch 1110 are opened, and refrigerant is compressed in the compressor 110 and output from one end of the compressor 110. Then, the refrigerant flows along the in-cabin condenser 120, the second two-way valve 1102, the first expansion valve 1103, the second one-way valve 1101, the second heat exchanger 140, the third two-way valve 1111, and the gas-liquid separator 160, and then returns to the compressor 110. In this process, high-temperature refrigerant condenses and releases heat at the in-cabin condenser 120 to heat the passenger compartment, while low-temperature refrigerant evaporates and absorbs heat at the second heat exchanger 140, to absorb heat in the air.

Passenger compartment heating mode 2: When the outdoor environment is excessively cold, heat absorbed in the air by only the second heat exchanger 140 is not enough to meet a heating demand. However, excess heat exits in the electric-powertrain water passage 200, which can be absorbed and utilized for heating indoor spaces. As shown in FIG. 4, the second two-way valve 1102 on the first section 1104 of the pre-heating branch 1100 is opened, and the first section 1104 of the pre-heating branch 1100 is in communication with the first heat exchange channel 510, and at the same time, the control valve group 600 is set to the second state to communicate the electric-powertrain water passage 200 and the second heat exchange channel 520 in series. In this mode, the direct connection branch 250 and the electric-powertrain 201 are in communication in series, and the second radiator 240 and the electric-powertrain 201 are out of communication. With this configuration, excess heat in the electric-powertrain water passage 200 is transferred to the first heat exchanger 500 through flowing of coolant, so that the heat pump module 100 can absorb heat on the first heat exchanger 500 during circulation, to improve heating performance of the heat pump module 100.

Passenger compartment heating mode 3: When the outdoor environment is excessively cold, heat absorbed in the air by only the second heat exchanger 140 is not enough to meet a heating demand. However, when the vehicle is performing hybrid motion, the components of the engine 311 also have high heat, which can also be absorbed and utilized to heat the indoor space. As shown in FIG. 5, the second two-way valve 1102 on the first section 1104 of the pre-heating branch 1100 is opened, and the first section 1104 of the pre-heating branch 1100 is in communication with the first heat exchange channel 510, and at the same time, the control valve group 600 is set to the first state to communicate the engine water passage 310 and the second heat exchange channel 520 in series. In this mode, the engine water passage 310 and the first radiator water passage 313 are out of communication. With this configuration, excess heat in the engine water passage 310 is transferred to the first heat exchanger 500 through flowing of coolant, so that the heat pump module 100 can absorb heat on the first heat exchanger 500 during circulation, to improve heating performance of the heat pump module 100. In some embodiments, as shown in FIG. 6, vehicle exhaust also contains an amount of heat. An exhaust heat exchanger 700 can be arranged and in communication with the engine water passage 310 in parallel, to recover the heat in the exhaust and transfer the heat to the first heat exchanger 500 through the second heat exchange channel 520.

Passenger compartment heating mode 4: When the outdoor environment is excessively cold, heat absorbed in the air by only the second heat exchanger 140 of the heat pump module 100 is not enough to meet a heating demand. As shown in FIG. 7, in this case, the control valve group 600 is set to the fourth state to allow the warm-air water passage 320 to be in a self circulating mode, and the heater 323 is started to heat coolant. At the same time, the warm-air core 321 is started to transfer heat of the coolant to the passenger compartment, to supplement heating of the heat pump module 100, so as to improve overall heating performance of the thermal management system 1.

Passenger compartment heating mode 5: When the outdoor environment is excessively cold, heat absorbed in the air by only the second heat exchanger 140 of the heat pump module 100 is not enough to meet a heating demand. As shown in FIG. 8, in this case, the control valve group 600 is set to the third state, to communicate the warm-air water passage 320 and the engine water passage 310 in series, and the warm-air core 321 is started to transfer heat of the engine 311 to the passenger compartment, to supplement heating of the heat pump module 100, so as to improve overall heating performance of the thermal management system 1.

In some embodiments, as shown in FIG. 9, vehicle exhaust also contains an amount of heat. An exhaust heat exchanger 700 can be arranged and in communication with the engine water passage 310 in parallel, to recover the heat in the exhaust and transfer the heat in the exhaust to the passenger compartment through the warm-air core 321.

Electric-powertrain 201 heating mode 1: To keep the electric-powertrain 201 at a suitable temperature to ensure efficient operation, the electric-powertrain 201 needs to be heated when an environment temperature is low. As shown in FIG. 10, in this case, the control valve group 600 is set to the sixth state, the electric-powertrain water passage 200, the engine water passage 310, and the second heat exchange channel 520 are in communication in series. In this mode, the direct connection branch 250 and the electric-powertrain 201 are in communication in series, and the second radiator 240 and the electric-powertrain 201 are out of communication. With this configuration, excess heat in the engine water passage 310 is transferred to the electric-powertrain water passage 200 through flowing of coolant, to heat the electric-powertrain 201 by using excess heat of the engine 311, so as to improve energy utilization efficiency of the thermal management system 1.

Electric-powertrain 201 heating mode 2: To keep the electric-powertrain 201 at a suitable temperature to ensure efficient operation, the electric-powertrain 201 needs to be heated when an environment temperature is low. As shown in FIG. 11, in this case, the control valve group 600 is set to the fifth state, the electric-powertrain water passage 200, the warm-air water passage 320, and the second heat exchange channel 520 are in communication in series. In this mode, the direct connection branch 250 and the electric-powertrain 201 are in communication in series, and the second radiator 240 and the electric-powertrain 201 are out of communication. At the same time, the heater 323 is started, and heat generated by the heater 323 is transferred to the electric-powertrain water passage 200 through flowing of coolant. This is applicable to a case in which heat of the engine 311 cannot meet a heating demand of the electric-powertrain 201, and can implement effective heating of the electric-powertrain 201.

Engine heating mode: To allow the engine 311 to quickly reach a suitable temperature after start to ensure efficient operation, the engine 311 needs to be warmed up. As shown in FIG. 8, in this case, the control valve group 600 is set to the third state, to communicate the warm-air water passage 320 and the engine water passage 310 in series, and the heater 323 is started. Heat generated by the heater 323 is transferred to the engine 311, to implement effective heating of the engine 311.

In addition, when the battery needs to be heated, a polyimide (Polyimide, PI) heating film can be selected to arrange on the battery to heat the battery, so as to meet a heating demand of the battery simply and reliably.

In conclusion, during use of the vehicle, the heat pump module 100, the electric-powertrain water passage 200, the engine water passage 310, and the battery direct cooling plate 400 arranged on the vehicle are controlled and adjusted by using the thermal management system 1, to properly utilize heat generated during operation of the vehicle and improve a driving range of the vehicle, and the vehicle has a high degree of integration.

Other configurations and operations of the vehicle according to the embodiments of the present invention are known to those of ordinary skill in the art and will not be described in detail herein.

In the description of this specification, the description of the reference terms such as “an embodiment”, “some embodiments”, “exemplary embodiments”, “example”, “specific example”, or “some examples” means that the features, structures, materials or characteristics described with reference to the embodiment or example are included in at least one embodiment or example of the present disclosure. In this specification, descriptions of the foregoing terms do not necessarily refer to the same embodiment or example. In addition, the described features, structures, materials, or characteristics may be combined in a proper manner in any one or more of the embodiments or examples.

Although the embodiments of the present disclosure have been shown and described, a person of ordinary skill in the art should understand that various changes, modifications, replacements and variations may be made to the embodiments without departing from the principles and spirit of the present disclosure, and the scope of the present disclosure is as defined by the appended claims and their equivalents.

What is claimed is:

1. A thermal management system, comprising:
a heat pump;
an electric-powertrain water passage;
an engine water passage;
a first heat exchanger having a first heat exchange channel and a second heat exchange channel, and the first heat exchange channel being in communication with the heat pump;
a battery cooling plate being in communication with the heat pump; and
a control valve group being in communication with the electric-powertrain water passage, the engine water passage, and the second heat exchange channel, and the control valve group being switchable between a first state and a second state;
wherein when the control valve group is in the first state, the engine water passage and the second heat exchange channel are in communication; and
when the control valve group is in the second state, the electric-powertrain water passage and the second heat exchange channel are in communication.

2. The thermal management system according to claim 1, further comprising a warm-air water passage, a warm-air core being disposed on the warm-air water passage, and the warm-air water passage being in communication with the engine water passage and the second heat exchange channel through the control valve group; and
when the control valve group is in the first state, the engine water passage, the warm-air water passage, and the second heat exchange channel being in communication in series.

3. The thermal management system according to claim 2, wherein the control valve group further has a third state, and when the control valve group is in the third state, the engine water passage and the warm-air water passage are in communication.

4. The thermal management system according to claim 3, wherein the control valve group further has a fourth state, and when the control valve group is in the fourth state, the warm-air water passage is in a self circulating mode.

5. The thermal management system according to claim 4, wherein the control valve group further has a fifth state, and when the control valve group is in the fifth state, the electric-powertrain water passage, the warm-air water passage, and the second heat exchange channel are in communication in series.

6. The thermal management system according to claim 5, wherein the control valve group further has a sixth state, and when the control valve group is in the sixth state, the engine water passage, the electric-powertrain water passage, and the second heat exchange channel are in communication in series.

7. The thermal management system according to claim 1, wherein the control valve group comprises:
a first four-way valve, wherein the first four-way valve has a first valve port, a second valve port, a third valve port, and a fourth valve port, the first valve port is in communication with a first end of the electric-powertrain water passage, the second valve port is in communication with a second end of the electric-powertrain water passage, and the third valve port is in communication with a first end of the second heat exchange channel; and
a first three-way valve, wherein the first three-way valve has a fifth valve port, a sixth valve port, and a seventh valve port, the fifth valve port is in communication with a first end of the engine water passage, the sixth valve port and a second end of the engine water passage are in communication with a second end of the second heat exchange channel, and the seventh valve port is in communication with the fourth valve port;
wherein when the control valve group is in the first state, the third valve port is in communication with the fourth valve port, and the fifth valve port is in communication with the seventh valve port; and
when the control valve group is in the second state, the first valve port is in communication with the fourth valve port, the second valve port is in communication with the third valve port, and the sixth valve port is in communication with the seventh valve port.

8. The thermal management system according to claim 7, further comprising: a warm-air water passage, a warm-air core being disposed on the warm-air water passage, wherein the control valve group further comprises a second four-way valve, the second four-way valve has an eighth valve port, a ninth valve port, a tenth valve port, and an eleventh valve port, the eighth valve port is in communication with the first end of the engine water passage, the ninth valve port is in communication with the second end of the engine water passage, the tenth valve port is in communication with a first end of the warm-air water passage, a second end of the warm-air water passage is in communication with the second end of the second heat exchange channel, and the eleventh valve port is in communication with the fifth valve port; and
when the control valve group is in the first state, the eighth valve port is in communication with the eleventh valve port, the ninth valve port is in communication with the tenth valve port, and the engine water passage, the warm-air water passage, and the second heat exchange channel are in communication.

9. The thermal management system according to claim 8, wherein the control valve group further has a third state, and when the control valve group is in the third state, the fifth valve port is in communication with the sixth valve port, the eighth valve port is in communication with the eleventh valve port, the ninth valve port is in communication with the tenth valve port, and the engine water passage and the warm-air water passage are in communication.

10. The thermal management system according to claim 9, wherein the control valve group further has a fourth state, and when the control valve group is in the fourth state, the fifth valve port is in communication with the sixth valve port, the tenth valve port is in communication with the eleventh valve port, and the warm-air water passage is in a self circulating mode.

11. The thermal management system according to claim 10, wherein the control valve group further has a fifth state, and when the control valve group is in the fifth state, the first valve port is in communication with the fourth valve port, the second valve port is in communication with the third valve port, the sixth valve port is in communication with the seventh valve port, and the electric-powertrain water passage, the warm-air water passage, and the second heat exchange channel are in communication in series.

12. The thermal management system according to claim 11, wherein the control valve group further has a sixth state, and when the control valve group is in the sixth state, the first valve port is in communication with the fourth valve port, the second valve port is in communication with the third valve port, and the fifth valve port is in communication with the seventh valve port.

13. The thermal management system according to claim 1, further comprising: a first radiator water passage, a first radiator being connected to the first radiator water passage, a first end of the engine water passage being in communication with a first end of the first radiator water passage, a second end of the engine water passage being in communication with a second end of the first radiator water passage, and the engine water passage and the first radiator water passage being in communication or out of communication.

14. The thermal management system according to claim 1, wherein the electric-powertrain water passage comprises: an electric-powertrain and a second radiator, wherein the electric-powertrain and the second radiator are connected.

15. The thermal management system according to claim 14, wherein the electric-powertrain water passage further comprises: a connection branch, wherein the second radiator and the connection branch are in communication, and each of the second radiator and the connection branch switches between a state of being in communication with the electric-powertrain and a state of being out of communication with the el ectri c-p owertrain.

16. The thermal management system according to claim 1, wherein the heat pump comprises:
a compressor;
an in-cabin condenser, wherein a first end of the in-cabin condenser is in communication with a first end of the compressor;
a second heat exchanger, wherein a first end of the second heat exchanger is in communication with a second end of the in-cabin condenser through a pre-refrigeration branch, and a second end of the second heat exchanger is in communication with the second end of the in-cabin condenser through a pre-heating branch;
an in-cabin evaporator, wherein a first end of the in-cabin evaporator is in communication with the second end of the second heat exchanger through a post-refrigeration branch; and
a gas-liquid separator, wherein a first end of the gas-liquid separator is in communication with the first end of the second heat exchanger through a post-heating branch, the first end of the gas-liquid separator is in communication with a second end of the in-cabin evaporator, and a second end of the gas-liquid separator is in communication with a second end of the compressor.

17. The thermal management system according to claim 16, further comprising a first two-way valve disposed on the pre-refrigeration branch;
a first one-way valve disposed on the post-refrigeration branch, wherein the first one-way valve is configured to direct refrigerant of the second heat exchanger to flow to the in-cabin evaporator;
a second two-way valve, a first expansion valve, and a second one-way valve disposed on the pre-heating branch, wherein the second one-way valve is configured to direct refrigerant of the in-cabin condenser to flow to the second heat exchanger; and
a third two-way valve disposed on the post-heating branch.

18. The thermal management system according to claim 17, wherein the pre-heating branch comprises:
a first section, wherein a first end of the first section is in communication with the second end of the in-cabin condenser, and a second end of the first section is in communication with the first one-way valve and the first end of the in-cabin evaporator; and
a second section, wherein a first end of the second section is in communication with the second end of the first section, and a second end of the second section is in communication with the second end of the second heat exchanger;
wherein the second two-way valve is disposed on the first section, and the first expansion valve and the second one-way valve are disposed on the second section.

19. The thermal management system according to claim 18, wherein the gas-liquid separator comprises:
a first flow path, wherein a first end of the first flow path is in communication with the first one-way valve and the second end of the first section, and a second end of the first flow path is in communication with the first end of the in-cabin evaporator and the first end of the second section; and
a second flow path, wherein a first end of the second flow path is in communication with the second end of the in-cabin evaporator, the post-heating branch, and the first end of the second heat exchanger, and a second end of the second flow path is in communication with the second end of the compressor.

20. A vehicle, comprising: a thermal management system comprising:
a heat pump;
an electric-powertrain water passage;
an engine water passage;
a first heat exchanger having a first heat exchange channel and a second heat exchange channel, and the first heat exchange channel being in communication with the heat pump;
a battery cooling plate being in communication with the heat pump; and
a control valve group being in communication with the electric-powertrain water passage, the engine water passage, and the second heat exchange channel, and the control valve group being switchable between a first state and a second state;
wherein when the control valve group is in the first state, the engine water passage and the second heat exchange channel are in communication; and
when the control valve group is in the second state, the electric-powertrain water passage and the second heat exchange channel are in communication.
